(19) United States
(12) Patent Application Publication
(10) Pub. No.: US 2026/0082257 A1
(43) Pub. Date: Mar. 19, 2026

(54) MEASUREMENT REPORTING BASED ON MACHINE LEARNING IN WIRELESS COMMUNICATION SYSTEM

(71) Applicant: LG ELECTRONICS INC., Seoul (KR)

(72) Inventors: Sunghoon JUNG, Seoul (KR); Myoungsoo KIM, Seoul (KR); Han CHA, Seoul (KR)

(73) Assignee: LG ELECTRONICS INC., Seoul (KR)

(21) Appl. No.: 19/109,223

(22) PCT Filed: Sep. 26, 2023
(86) PCT No.: PCT/KR2023/014892

§ 371 Date: Mar. 6, 2025

Related U.S. Application Data
(60) Provisional application No. 63/410,238, filed on Sep. 27, 2022.

(51) Int. Cl. H04W 24/10; G06N 3/045; H04W 24/08

(52) U.S. Cl. CPC H04W 24/10; G06N 3/045; H04W 24/08

(57) ABSTRACT

The present disclosure relates to measurement reporting based on machine learning in wireless communications. According to an embodiment of the present disclosure, a method performed by a user equipment (UE) configured to operate in a wireless communication system comprises: receiving, from a network, a configuration for measurement reporting related to a plurality of machine learning (ML) models; determining a set of ML models for measurement reporting among the plurality of ML models configured for the UE, based on the configuration; obtaining measurement results by taking inputs to the set of ML models; and transmitting, to the network, at least one of the measurement results.

### CROSS-REFERENCE TO RELATED APPLICATIONS

This application is the National Stage filing under 35 U.S.C. 371 of International Application No. PCT/KR2023/014892, filed on Sep. 26, 2023, which claims the benefit of U.S. Provisional Application No. 63/410,238 filed on Sep. 27, 2022, the contents of which are all hereby incorporated by reference herein in their entireties.

### TECHNICAL FIELD

The present disclosure relates to measurement reporting based on machine learning in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

A user equipment (UE) may perform an actual measurement on reference signals related to a measurement target, to obtain measurement results. The UE may report the measurement results to network. UE may also obtain measurement results by using an artificial intelligence (AI)/machine learning (ML) model. UE may apply machine learning algorithms related to the AI/ML model to model inputs, and obtain AI/ML based measurement results.

### SUMMARY

An aspect of the present disclosure is to provide method and apparatus for measurement reporting based on machine learning in a wireless communication system.

Another aspect of the present disclosure is to provide method and apparatus for measurement reporting based on one or more ML models in a wireless communication system.

According to an embodiment of the present disclosure, a method performed by a user equipment (UE) configured to operate in a wireless communication system comprises: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

According to an embodiment of the present disclosure, a network node configured to operate in a wireless communication system comprises: at least one transceiver: at least one processor; and at least one memory operatively coupled to the at least one processor and storing instructions that, based on being executed by the at least one processor, perform operations comprising: transmitting to a user equipment (UE), a configuration for measurement reporting related to a plurality of machine learning (ML) models; and receiving, from the UE, at least one of measurement results obtained by taking inputs to a set of ML models for measurement reporting, wherein the set of ML models are determined among the plurality of ML models configured for the UE, based on the configuration.

According to an embodiment of the present disclosure, a method performed by a network node configured to operate in a wireless communication system comprises: transmitting to a user equipment (UE), a configuration for measurement reporting related to a plurality of machine learning (ML) models; and receiving, from the UE, at least one of measurement results obtained by taking inputs to a set of ML models for measurement reporting, wherein the set of ML models are determined among the plurality of ML models configured for the UE, based on the configuration.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

According to an embodiment of the present disclosure, a non-transitory computer readable medium (CRM) has stored thereon a program code implementing instructions that, based on being executed by at least one processor, perform operations comprising: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

The present disclosure may have various advantageous effects.

For example, UE can be configured to operate an optimal model, yielding better performance and/or low power consumption.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a functional framework for AI/ML according to an embodiment of the present disclosure.

FIG. 9 shows an example of a procedure for a normal measurement according to an embodiment of the present disclosure.

FIG. 10 shows an example of a procedure for a ML-aided/based measurement according to an embodiment of the present disclosure.

FIG. 11 shows an example of a method performed by a UE according to an embodiment of the present disclosure.

FIG. 12 shows an example of a method performed by a network node according to an embodiment of the present disclosure.

FIG. 13 shows an example of a procedure between UE and network for combined reporting and subsequent model down-selection according to an embodiment of the present disclosure.

FIG. 14 shows an example of concurrent measurements to derive model-specific output/measurement result for multiple models according to an embodiment of the present disclosure.

FIG. 15A shows an example of combined reporting of measurements derived from various measurement models according to an embodiment of the present disclosure.

FIG. 15B shows an example of combined reporting of measurements derived from various measurement models with output selection.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi). IEEE 802.16 (WiMAX). IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A). LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure. “A or B” may mean “only A”. “only B”, or “both A and B”. In other words. “A or B” in the present disclosure may be interpreted as “A and/or B”. For example. “A. B or C” in the present disclosure may mean “only A”. “only B”. “only C”, or “any combination of A. B and C”.

In the present disclosure, slash (/) or comma (,) may mean “and/or”. For example, “A/B” may mean “A and/or B”. Accordingly. “A/B” may mean “only A”. “only B”, or “both A and B”. For example. “A. B. C” may mean “A. B or C”.

In the present disclosure. “at least one of A and B” may mean “only A”. “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

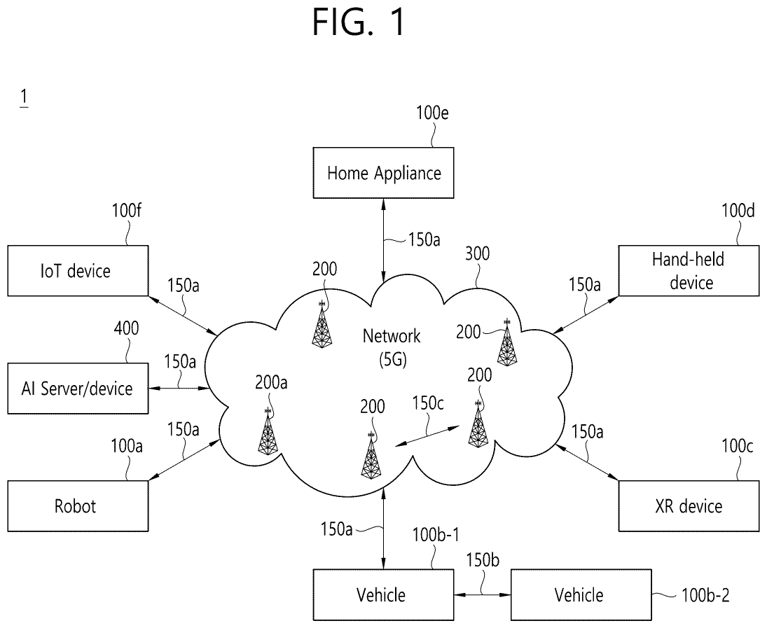

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 KHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

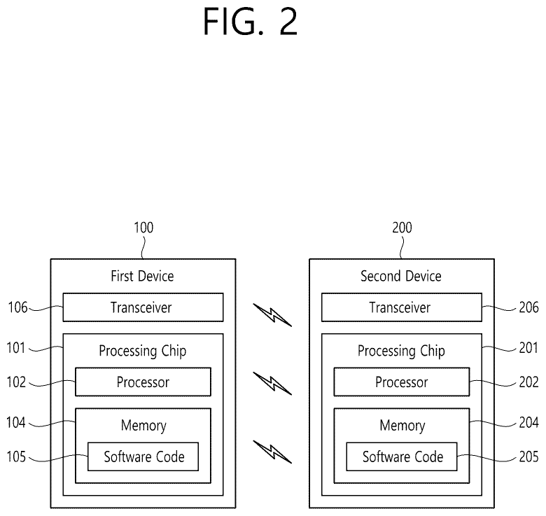

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2. The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer. Media Access Control (MAC) layer. Radio Link Control (RLC) layer. Packet Data Convergence Protocol (PDCP) layer. Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs. SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs. SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM). Dynamic RAM (DRAM). Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

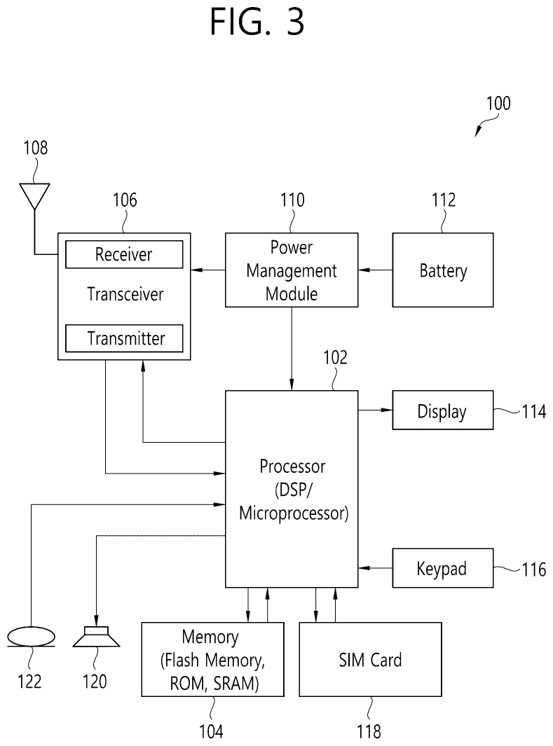

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

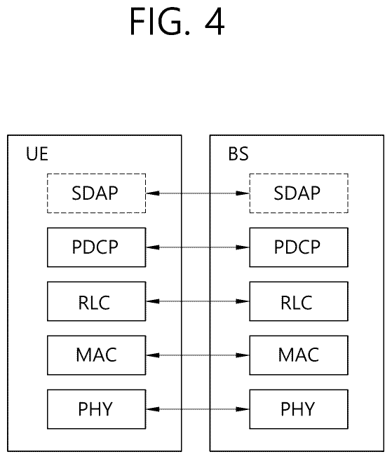

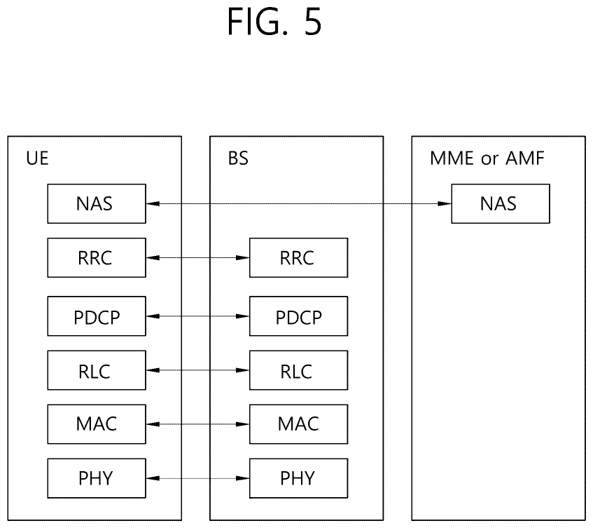

FIGS. 4 and 5 show an example of protocol stacks in a 3GPP based wireless communication system to which implementations of the present disclosure is applied.

In particular. FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer). Layer 2. Layer 3 (e.g., an RRC layer), and a non-access stratum (NAS) layer. Layer 1. Layer 2 and Layer 3 are referred to as an access stratum (AS).

In the 3GPP LTE system, the Layer 2 is split into the following sublayers: MAC. RLC, and PDCP. In the 3GPP NR system, the Layer 2 is split into the following sublayers: MAC. RLC. PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels: multiplexing/de-multiplexing of MAC SDUs belonging to one or different logical channels into/from transport blocks (TB) delivered to/from the physical layer on transport channels: scheduling information reporting; error correction through hybrid automatic repeat request (HARQ) (one HARQ entity per cell in case of carrier aggregation (CA)): priority handling between UEs by means of dynamic scheduling: priority handling between logical channels of one UE by means of logical channel prioritization: padding. A single MAC entity may support multiple numerologies, transmission timings and cells. Mapping restrictions in logical channel prioritization control which numerology (ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH): BCCH can be mapped to downlink shared channel (DL-SCH): PCCH can be mapped to paging channel (PCH): CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH): DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs: sequence numbering independent of the one in PDCP (UM and AM): error correction through ARQ (AM only); segmentation (AM and UM) and re-segmentation (AM only) of RLC SDUs: reassembly of SDU (AM and UM): duplicate detection (AM only): RLC SDU discard (AM and UM); RLC re-establishment: protocol error detection (AM only).

In the 3GPP NR system, the main services and functions of the PDCP sublayer for the user plane include: sequence numbering: header compression and decompression using robust header compression (ROHC): transfer of user data: reordering and duplicate detection; in-order delivery: PDCP PDU routing (in case of split bearers): retransmission of PDCP SDUs; ciphering, deciphering and integrity protection: PDCP SDU discard: PDCP re-establishment and data recovery for RLC AM: PDCP status reporting for RLC AM: duplication of PDCP PDUs and duplicate discard indication to lower layers. The main services and functions of the PDCP sublayer for the control plane include: sequence numbering: ciphering, deciphering and integrity protection: transfer of control plane data: reordering and duplicate detection: in-order delivery: duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS: paging initiated by 5GC or NG-RAN; establishment, maintenance and release of an RRC connection between the UE and NG-RAN; security functions including key management: establishment, configuration, maintenance and release of signaling radio bearers (SRBs) and data radio bearers (DRBs): mobility functions (including: handover and context transfer. UE cell selection and reselection and control of cell selection and reselection, inter-RAT mobility); QoS management functions: UE measurement reporting and control of the reporting: detection of and recovery from radio link failure: NAS message transfer to/from NAS from/to UE.

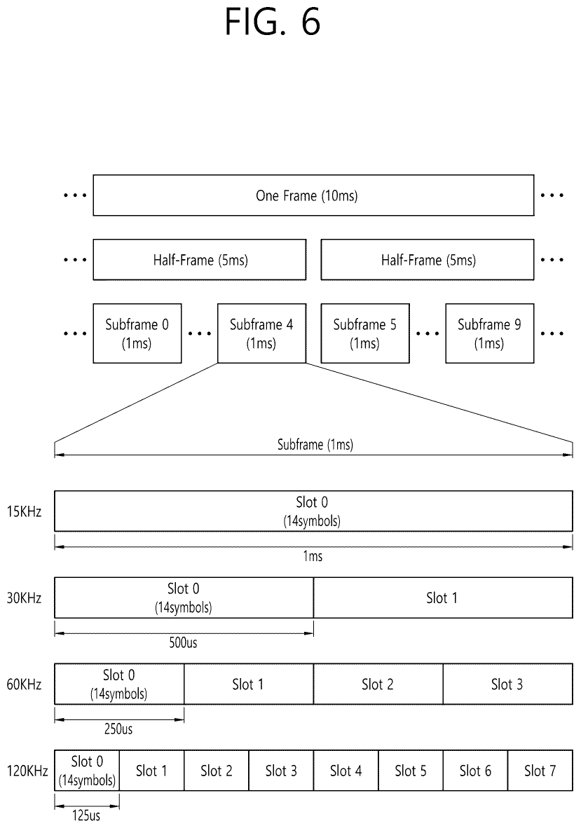

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system. OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols). SC-FDMA symbols (or discrete Fourier transform-spread-OFDM (DFT-s-OFDM) symbols).

Referring to FIG. 6, downlink and uplink transmissions are organized into frames. Each frame has Tr=10 ms duration. Each frame is divided into two half-frames, where each of the half-frames has 5 ms duration. Each half-frame consists of 5 subframes, where the duration Tsf per subframe is Ims. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 KHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 KHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is Ims, which is the same as the subframe length. When SCS is 30 KHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 KHz. When SCS is 120 kHz, the slot length is 0.125 ms (=125 us), and the symbol length is half of that when the SCS is 60 KHz. When SCS is 240 kHz, the slot length is 0.0625 ms (=62.5 us), and the symbol length is half of that when the SCS is 120 KHz.

In the 3GPP NR system. RBs are classified into CRBs and physical resource blocks (PRBs). CRBs are numbered from 0 and upwards in the frequency domain for subcarrier spacing configuration u. The center of subcarrier 0 of CRB 0) for subcarrier spacing configuration u coincides with ‘point A’ which serves as a common reference point for resource block grids. In the 3GPP NR system. PRBs are defined within a bandwidth part (BWP) and numbered from ( ) to N^{size}_{BWpi}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}. Where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

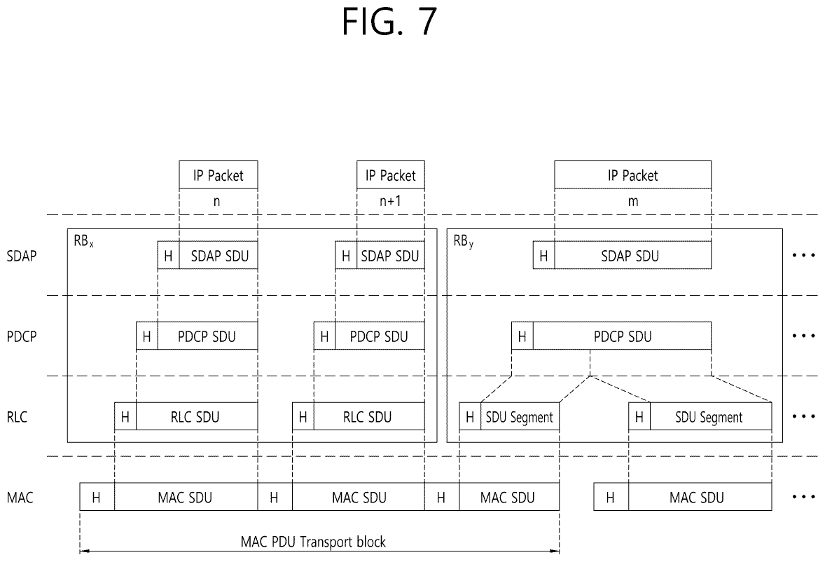

FIG. 7 shows a data flow example in the 3GPP NR system to which implementations of the present disclosure is applied.

Referring to FIG. 7. “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, artificial intelligence (AI)/machine learning (ML) related features are described.

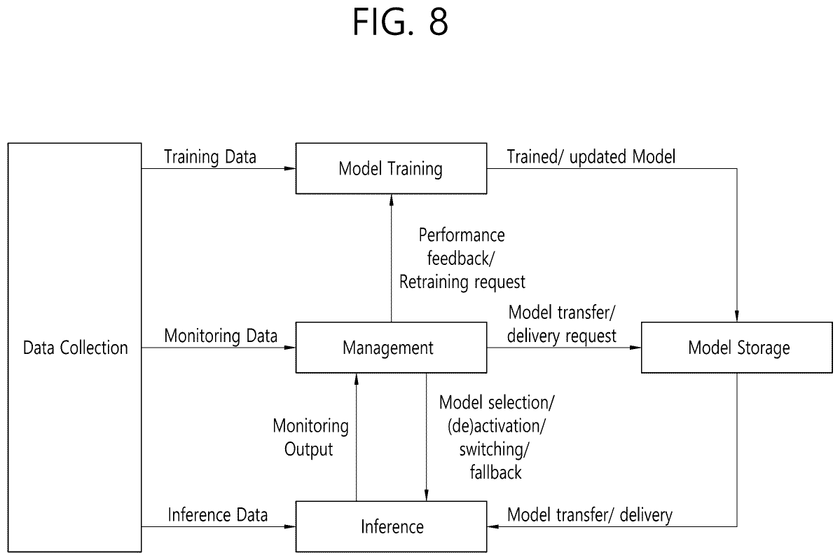

FIG. 8 shows an example of a functional framework for AI/ML according to an embodiment of the present disclosure.

In FIG. 8, Data Collection is a function that provides input data to the Model Training. Management, and Inference functions. The input data may comprise at least one of:
Training Data needed as input for the AI/ML Model Training function:
Monitoring Data needed as input for the Management of AI/ML Models or AI/ML functionalities: or
Inference Data needed as input for the AI/ML Inference function.

For example, the monitoring data may comprise at least one of:
beam prediction accuracy related KPIs, e.g., Top-K/1 beam prediction accuracy:
link quality related KPIs, e.g., throughput, L1-RSRP. L1-SINR, hypothetical BLER:
   performance metric based on input/output data distribution of AI/ML: or
   the L1-RSRP difference evaluated by comparing measured RSRP and predicted RSRP.

The Model Training function performs the AI/ML model training, validation, and testing which may generate model performance metrics which can be used as part of the model testing procedure. The Model Training function is also responsible for data preparation (e.g., data pre-processing and cleaning, formatting, and transformation) based on Training Data delivered by a Data Collection function, if required. In case of having a Model Storage function, the Model Training function is used to deliver trained, validated, and tested AI/ML models (i.e., Trained model) to the Model Storage function, or to deliver an updated version of a model (i.e., updated model) to the Model Storage function.

Management is a function that oversees the operation (e.g., selection/(de) activation/switching/fallback) and monitoring of AI/ML models or AI/ML functionalities. This function is also responsible for making decisions to ensure the proper inference operation based on data received from the Data Collection function and the Inference function. Selection/(de) activation/switching/fallback is information needed as input to manage the Inference function. Concerning information may include selection/(de) activation/switching of AI/ML models or AI/ML-based functionalities, fallback to non-AI/ML operation (i.e., not relying on inference process). Model Transfer/Delivery Request is used to request model(s) to the Model Storage function. Performance feedback/Retraining request is information needed as input for the Model Training function, e.g., for model (re) training or updating purposes.

Inference is a function that provides outputs from the process of applying AI/ML models or AI/ML functionalities to new data (i.e., Inference Data). The Inference function is also responsible for data preparation (e.g., data pre-processing and cleaning, formatting, and transformation) based on Inference Data delivered by a Data Collection function, if required. Inference Output is data used by the Management function to monitor the performance of AI/ML models or AI/ML functionalities.

Model Storage is a function responsible for storing trained/updated models that can be used to perform the inference process. The Model Storage function, if any, is primarily intended as a reference point when applicable, for protocol terminations, model transfer/delivery, and related processes. It should be stressed that its purpose does not encompass restricting the actual storage locations of models. Model Transfer/Delivery is used to deliver an AI/ML model to the Inference function.

Normally. UE may perform a measurement based on actual measurement of known reference signal and derives measurement result strictly based on the actual measurement possibly with post-processing of the measurement results of the reference signals (e.g., filtering based on linear average or exponential moving average or etc.). In the present disclosure, this type of normal measurement may be denoted as a first type measurement.

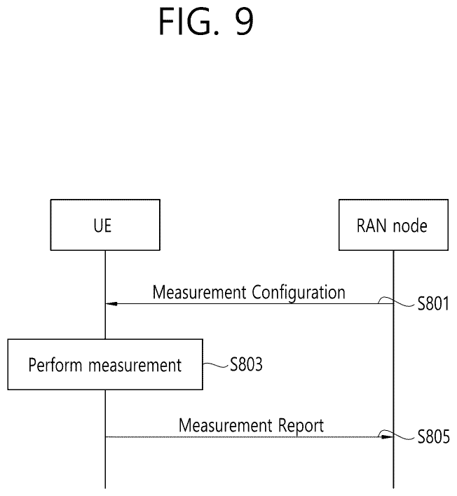

FIG. 9 shows an example of a procedure for a normal measurement according to an embodiment of the present disclosure.

Referring to FIG. 9, in step S901, the UE may receive, from a network, a measurement configuration. The measurement configuration may comprise a list of measurement objects (measObject), a list of report configurations (reportConfig), and a list of measurement identifiers ID, measID). The measurement ID may be related to/correspond to a combination of a measurement object and a report configuration. The measurement object may indicate object information regarding an object the UE is supposed to measure. For example, the object information may comprise a measurement frequency and/or a list of cells including serving cell/neighbor cell(s). The report configuration may comprise a condition to perform an action corresponding to a report type in the report configuration. For example, the condition may comprise a report condition that should be satisfied for the UE to transmit a measurement report.

In step S903, the UE may perform a measurement based on the measurement configuration. For example, the UE may measure reference signals received from the serving cell and/or the neighbor cell(s) on the measurement frequency specified by the measurement object, to obtain a measurement result for the serving cell and/or the neighbor cell(s). The measurement result may comprise a cell quality/signal strength/signal quality/channel quality/channel state/reference signal received power (RSRP)/reference signal received quality (RSRQ) of the serving cell and/or the neighbor cell(s). The UE may perform an actual measurement of the reference signals, and derive a measurement result based on the actual measurement possibly with post-processing of the measurement results of the reference signals (e.g., filtering based on linear average or exponential moving average or etc.).

In step S905, the UE may transmit a measurement report to the network. The UE may transmit the measurement report comprising the measurement result for the serving cell and/or the neighbor cell(s) to the network based on the report configuration (e.g., when the report condition is satisfied).

In addition. UE may perform a ML-aided/based measurement, where the ML-aided/based measurement is the measurement process in which measurement result are derived with assistance of ML (on top of some measurement of known reference signals). The ML-aided/based measurement may be related to compressing the measurement results in size, so as to reduce reporting overhead. For example, auto-encoder/DNN/CNN based machine learning can be used to enable compressed CSI reporting by generating compressed CSI information at UE side and reconstructing the desired CSI information at network side, i.e., two-sided ML algorithm can be used. The ML-aided/based measurement may be related to predicting measurement results for future time. The measurement prediction can be done based on using the current and/or past measurement results and other local/environmental/useful information available at the UE side and a machine learning model taking the available measurement and possibly the available information as input. In the present disclosure, this type of ML-aided/based measurement may be denoted as a second type measurement.

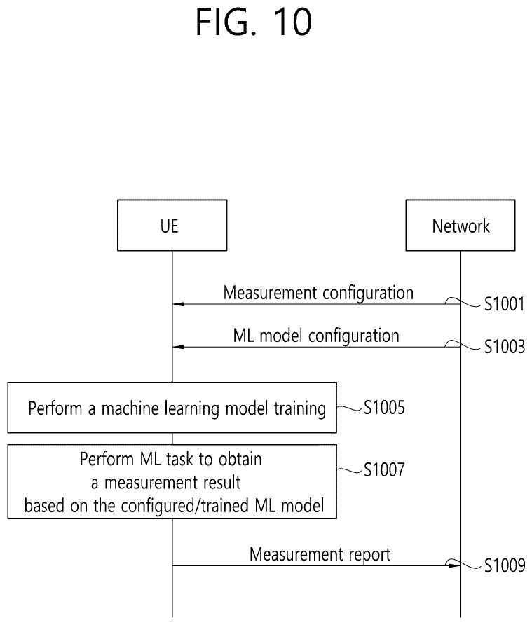

FIG. 10 shows an example of a procedure for a ML-aided/based measurement according to an embodiment of the present disclosure.

Referring to FIG. 10, in step S1001. UE may receive, from a network, a measurement configuration. The measurement configuration may comprise information elements as described in step 901 of FIG. 9.

In step S1003. UE may receive ML model configuration from the network. For deriving the ML-assisted result. UE may be provided with the ML model configuration. The ML model configuration may comprise prediction model structure information.

In some implementations, the order of steps S1001 and S1003 may be changed, or steps S1001 and S1003 may be performed at the same time. For example, the measurement configuration may comprise the ML model configuration.

In some implementations, the ML model information may comprise a machine learning type, such as reinforcement learning, supervised learning, or unsupervised learning.

In some implementations, network may configure a machine learning model to be used by UE. The ML model information may comprise a machine learning model, such as deep neural network (DNN), convolution neural network (CNN), recurrent neural network (RNN), and deep reinforcement learning (DRL).

For example, the configured ML model may be a pre-trained ML model that has been already trained by network a-priori. The configured ML model may be described by a model description information including model structure and parameters. For example, neural-network based model may comprise input layer, output layer, and hidden layer(s), where each layer comprises one or more neurons (equivalently nodes). Different layers are connected based on the connections between neurons of different layers. Each connection of two different neurons in two different layers may be directive (e.g, neuron A to neuron B, meaning that the output of neuron A is fed into the neuron B). Each neuron may provide input to one or several connected neurons (1 to N connection). For a connection between two neurons (neuron A to neuron B), output of one neuron A is scaled by a weight, and the other neuron takes the scaled output as its input. Each neuron may take input from one or several connected neurons (N to 1 connection), and combines the input from the connected neurons, and produces an output based on activation function.

For example, the configured ML model may be a ML model to be trained. The configured ML model is described by a model description information including model structure and initial parameters that are to be trained. When network configures the ML model to be trained, it may also configure training parameters such as optimization objective(s) and optimization-related configuration parameters.

In some implementations, the ML model configuration may comprise machine learning input parameters for the machine learning model, such as UE location information, radio measurements related to serving cell and neighbouring cells. UE mobility history.

In some implementations, the ML model configuration may comprise learning output, such as UE trajectory prediction, predicted target cell, prediction time for handover, and UE traffic prediction.

In step S1005. UE may perform a machine learning model training, validation, and testing which may generate model performance metrics based on the prediction model configuration/ML model configuration. UE may perform a model training with the machine learning input parameters. In some implementations, step S1005 may be performed when the UE is configured with a ML model to be trained—that is, when the UE is configured with a pre-trained ML model that has been already trained by network a-priori, step S1005 may be skipped.

In step S1007. UE may perform ML task such as predictions of measurements based on the configured/trained ML model. UE may derive machine learning output(s), which may be a measurement result. In some implementations. UE may infer the measurement result from the outputs and use the outputs as feedback for the machine learning model.

In step S1009. UE may transmit, to the network, a measurement report comprising the measurement result derived based on the configured/trained ML model.

The use of ML-aided/based measurement reporting can be useful for reducing reporting overhead if ML is used for information compression/reconstruction. The ML-aided/based measurement reporting can assist network to optimize data scheduling and mobility of the concerned UE if the ML is used for estimating or predicting measurement results in time and/or in frequency beyond the current/past measurements available. However, there exists a risk that ML-aided/based measurement may suffer from low accuracy. Low accuracy of ML-aided/based measurement may be caused by several factors possibly including invalid model selection, insufficient or imperfect model training, invalid side information used as input for the ML algorithm, etc. If network uses inaccurate ML-aided/based measurement, it will result in waste of radio resources, data communication quality degradation, mobility performance degradation, etc. So, it is important to ensure that network can validate if the reported ML-aided/based measurements are valid or accurate enough.

Different ML models produce different outputs. Different models requires different computational complexity and power consumption. Different models yield different accuracy. Currently, measurement task is based on a single model. If UE supports multiple models and performing concurrent measurements and/or concurrent measurement result derivation process for multiple models, network can select/reselect a model to enhance performance and/or to reduce UE power consumption.

In the present disclosure. UE may be configured with a list of models for measurement. The model may be used to produce measurement results by taking input to the model and performing mathematical operations to yield output. The model may be a trained model so that it can be ready to produce output that can be considered valid based on valid input. For each model of configured models, UE may perform measurements (model-specific measurement) and derive measurement results (model-specific measurement result) by using the model. UE may combine/aggregate the model-specific measurement results for the configured models. UE may report the combined measurement results to network.

The measurements may be related to quality evaluation of a RS, a specific RS or a specific set of RSs for CSI measurements or positioning measurements. The measurements may be related to quality evaluation of a cell, a specific cell, or a specific set of cells or a specific frequency for RRM measurements. The measurements may be related to measurement prediction in time/frequency domain.

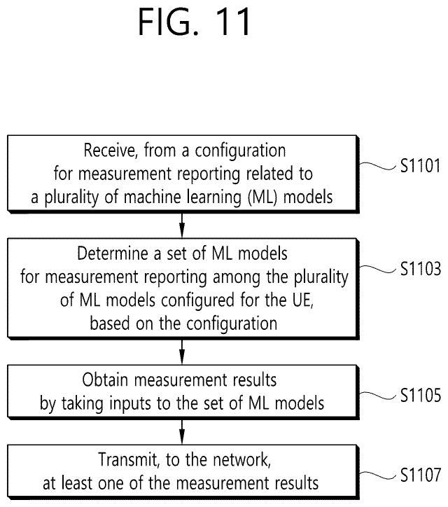

FIG. 11 shows an example of a method performed by a UE according to an embodiment of the present disclosure. The method may also be performed by a wireless device.

Referring to FIG. 11, in step S1101, the UE may receive, from a network, a configuration for measurement reporting related to a plurality of machine learning (ML) models.

In step S1103, the UE may determine a set of ML models for measurement reporting among the plurality of ML models configured for the UE, based on the configuration.

In step S1105, the UE may obtain measurement results by taking inputs to the set of ML models.

In step S1107, the UE may transmit, to the network, at least one of the measurement results.

According to various embodiments, the measurement results may comprise a measurement result obtained by taking an input to a corresponding ML model in the set of ML models. The input may comprise at least one of: one or more ML input parameters received from the network: one or more reference signals: measurement values of the one or more reference signals: or a past measurement result. The measurement result may comprise at least one of: an output of the corresponding ML model for the input: a compressed measurement result: a predicted measurement result derived from measurement results including the past measurement result: a predicted measurement result of a reference signal derived from the measurement result of other reference signal: or beam indexes of one or more beams in descending order of beam quality from a beam with highest beam quality. The one or more ML input parameters may comprise at least one of location information of the UE, measurement results for at least one reference signal configured to the UE, measurement results for at least one of a serving cell or one or more neighbor cells, or mobility history information of the UE.

According to various embodiments, the plurality of ML models may comprise at least one of a deep neural network (DNN) model, a convolution neural network (CNN) model, a recurrent neural network (RNN) model, or a deep reinforcement learning (DRL) model.

According to various embodiments, the UE may apply an ML algorithm corresponding to an ML model to an input of the ML model, to obtain a measurement result as an output of the ML model.

According to various embodiments, the configuration may comprise at least one of: a list of the plurality of ML models: ML model information informing the set of ML models: or a condition to determine the set of ML models.

According to various embodiments, the UE may transmit, to the network, capability information of the UE informing supported ML models for measurement reporting. After transmitting the capability information, the UE may receive, from the network, an ML model configuration comprising the plurality of ML models. The plurality of ML models may be determined among the supported ML models.

According to various embodiments, the UE may obtain model-specific measurement results by taking inputs to the plurality of ML models. The UE may transmit, to the network, a measurement report comprising the model-specific measurement results. The UE may receive the configuration from the network after transmitting the measurement report.

According to various embodiments, the set of ML models may be determined based on the model-specific measurement results.

According to various embodiments, the inputs may comprise a common input taken to at least two ML models in the set of ML models.

According to various embodiments, the inputs may comprise model-specific inputs each of which is taken to a corresponding ML model in the set of ML models.

According to various embodiments, the UE may transmit, to the network, model preference information informing one or more ML models preferred by the UE. At least one of the plurality of ML models or the set of ML models may be determined based on the preference information.

According to various embodiments, the one or more ML models may be determined based on at least one of a power consumption, an accuracy, validity, user preference, or priority of each ML model.

According to various embodiments, the model preference information may be transmitted via at least one of a measurement report or UE assistance information.

According to various embodiments, the UE may receive a list of models for measurement. The UE may perform measurements based on each model of the received models. The UE may send measurement results including measurement results derived from more than one received models.

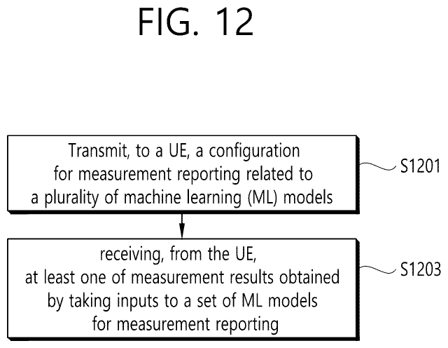

FIG. 12 shows an example of a method performed by a network node according to an embodiment of the present disclosure. The network node may comprise a base station (BS).

Referring to FIG. 12, in step S1201, the network node may transmit, to a UE, a configuration for measurement reporting related to a plurality of machine learning (ML) models.

In step S1203, the network node may transmit, to the UE, ML model information informing a set of ML models for measurement reporting. The set of ML models may be determined among the plurality of ML models configured for the UE, based on the configuration.

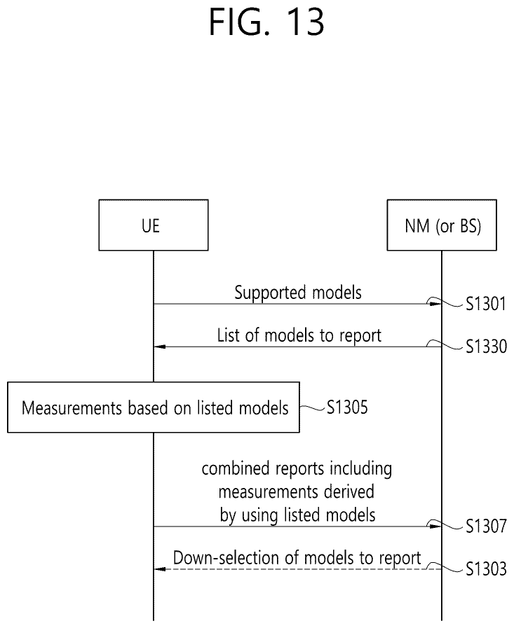

FIG. 13 shows an example of a procedure between UE and network for combined reporting and subsequent model down-selection according to an embodiment of the present disclosure. The combined reporting may be performed by UE, and the model down-selection may be triggered by the network.

Referring to FIG. 13, in step S1301, UE may inform network about its capability of supported models that can be used for measurements. UE may transmit, to the network, information for UE's capability of supported models that can be used for measurements.

In step S1303, the network may configure UE with a list of models to be used for combined reporting. The network may transmit, to UE, an ML model configuration comprising a list of models to be used for combined reporting.

In step S1305, UE may perform measurements by using the list of models. UE may derive model-specific measurement results for each used model among the configured models. UE may combine/aggregate the model-specific measurement results for the configured models.

In step S1307, UE may report the combined measurement results to network. UE may transmit, to the network, a measurement report message comprising the combined measurement results.

Network may receive the combined measurement results. Then, the network may select a set of models to be used by UE for subsequent measurements and reporting, among the list of models configured for UE in step S1303.

In step S1309, network may configure the UE with the selected set of models for subsequent measurements and reporting. Network may transmit, to the UE, ML model information informing the selected set of models for subsequent measurements and reporting.

UE may determine the set of models based on the ML model information. UE may perform measurement by using the set of models. UE may transmit a measurement report comprising the derived measurement results to network. If more than one model is configured in the set of models, UE may transmit a measurement report comprising a combined report including multiple sets of measurement results each derived from the different models of the set of models. Otherwise (i.e., one model is configured in the set of models), the UE may transmit a measurement report including a single set of measurement results derived from the configured model.

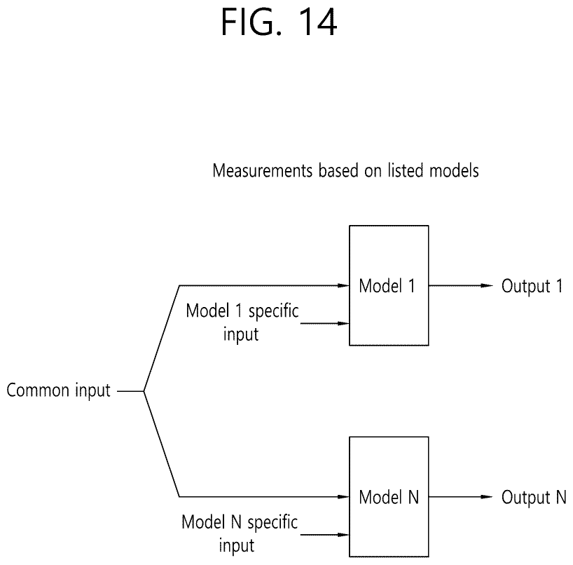

Step S1305 will be described in detail with reference to FIG. 14.

FIG. 14 shows an example of concurrent measurements to derive model-specific output/measurement result for multiple models according to an embodiment of the present disclosure.

In FIG. 14, UE may be configured with Model1, Model2, [symbol] , Model N for measurements. Each model may take its input.

In some implementations, there may be a common input that is used as input of multiple or all configured models. For example, a set of known RSs or measurement results of the set of known RSs can be taken as the common input.

In some implementations, there may be a model-specific input to be used for a specific model. For example, a specific set of RSs or measurement results of the RSs may be used as input for a specific model and another specific set of RSs may be used as input for another specific model. For example, a specific set of measurement results may be used as input for a specific model and another specific set of measurement results may be used as input for another specific model.

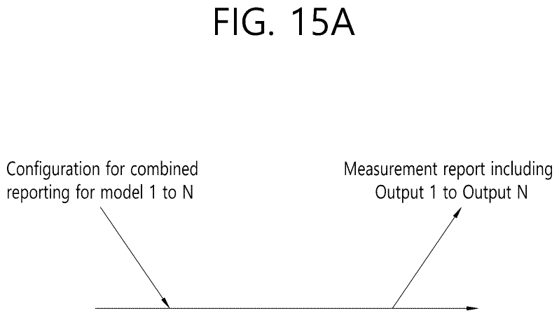

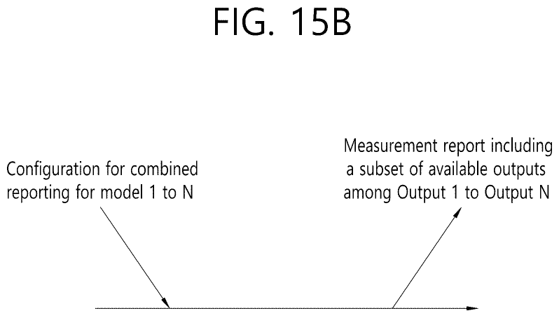

As shown in step S1303 and S1309 in FIG. 13, UE can be configured with a list of models (in step S1303) and/or a set of models among the configured models (in step S1309), for concurrent measurements and combined reporting based on multiple models. Depending on UE capabilities, UE may perform concurrent measurements and report measurement results for all configured models as shown in FIG. 15A or UE may perform concurrent measurements and report measurement results for a subset of configured models as shown in FIG. 15B.

FIG. 15A shows an example of combined reporting of measurements derived from various measurement models according to an embodiment of the present disclosure.

Referring to FIG. 15A, UE may receive configuration for combined reporting for models 1 to N from a network at time/period t1. Then, UE may transmit a measurement report including outputs 1 to N to the network at time/period t2, where output k (1≤k≤N, k is integer) is derived from model k.

FIG. 15B shows an example of combined reporting of measurements derived from various measurement models with output selection.

Referring to FIG. 15B, UE may receive configuration for combined reporting for models 1 to N from a network at time/period t1. UE may receive ML model information informing a set of models, among the models 1 to N configured for UE at time/period t1. Then, UE may transmit a measurement report including a subset of available outputs among outputs 1 to N to the network at time/period t2, where:
output k (1≤k≤N, k is integer) is derived from model k; and
the subset of available outputs are derived from the set of models informed by the ML model information.

UE may indicate to network one or more models that it prefers to be configured. UE may evaluate power consumption of each model and accuracy of each model for determination of its preference. UE may indicate its preference within the combined reporting. UE may indicate its preference in a separate message (e.g., in UE assistance information message, which is RRC message).

Furthermore, the method in perspective of the UE described in the present disclosure (e.g., in FIG. 11) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

Furthermore, the method in perspective of the UE described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

Furthermore, the method in perspective of the UE described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network, a configuration for measurement reporting related to a plurality of machine learning (ML) models: determining a set of ML models for measurement reporting among the plurality of ML models configured for the UE, based on the configuration: obtaining measurement results by taking inputs to the set of ML models; and transmitting, to the network, at least one of the measurement results.

Furthermore, the method in perspective of a network node related to a first cell described in the present disclosure (e.g., in FIG. 12) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting to a user equipment (UE), a machine learning (ML) model configuration comprising a plurality of ML models; and receiving, from the UE, at least one of measurement results obtained by taking inputs to a set of ML models for measurement reporting, wherein the set of ML models are determined among the plurality of ML models configured for the UE, based on the configuration.

The present disclosure may have various advantageous effects.

For example, UE can be configured to operate an optimal model, yielding better performance and/or low power consumption.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-21. (canceled)

22. A method comprising:
receiving, from a network, a configuration for measurement reporting related to a plurality of machine learning (ML) models;
determining a set of ML models for measurement reporting among the plurality of ML models, based on the configuration;
obtaining measurement results by taking inputs to the set of ML models; and
transmitting, to the network, at least one of the measurement results.

23. The method of claim 22, wherein the measurement results comprise a measurement result obtained by taking an input to a corresponding ML model in the set of ML models,
wherein the input comprises at least one of:
one or more ML input parameters received from the network;
one or more reference signals;
measurement values of the one or more reference signals: or
a past measurement result,
wherein the measurement result comprises at least one of:
an output of the corresponding ML model for the input;
a compressed measurement result;
a predicted measurement result derived from measurement results including the past measurement result;
a predicted measurement result of a reference signal derived from the measurement result of other reference signal: or
beam indexes of one or more beams in descending order of beam quality from a beam with highest beam quality, and
wherein the one or more ML input parameters comprise at least one of location information, measurement results for at least one reference signal, measurement results for at least one of a serving cell or one or more neighbor cells, or mobility history information.

24. The method of claim 22, wherein the plurality of ML models comprises at least one of a deep neural network (DNN) model, a convolution neural network (CNN) model, a recurrent neural network (RNN) model, or a deep reinforcement learning (DRL) model.

25. The method of claim 22, wherein the obtaining of the measurement results comprises applying an ML algorithm corresponding to an ML model to an input of the ML model, to obtain a measurement result as an output of the ML model.

26. The method of claim 22, wherein the configuration comprises at least one of:
a list of the plurality of ML models;
ML model information informing the set of ML models; or
a condition to determine the set of ML models.

27. The method of claim 22, further comprising:
transmitting, to the network, capability information informing supported ML models for measurement reporting; and
after transmitting the capability information, receiving, from the network, an ML model configuration comprising the plurality of ML models,
wherein the plurality of ML models is determined among the supported ML models.

28. The method of claim 22, further comprising:
obtaining model-specific measurement results by taking inputs to the plurality of ML models; and
transmitting, to the network, a measurement report comprising the model-specific measurement results,
wherein the receiving of the configuration comprises receiving the configuration from the network after transmitting the measurement report.

29. The method of claim 28, wherein the set of ML models are determined based on the model-specific measurement results.

30. The method of claim 22, wherein the inputs comprise a common input taken to at least two ML models in the set of ML models.

31. The method of claim 22, wherein the inputs comprise model-specific inputs each of which is taken to a corresponding ML model in the set of ML models.

32. The method of claim 22, further comprising:
transmitting, to the network, model preference information informing one or more ML models that are preferred,
wherein at least one of the plurality of ML models or the set of ML models is determined based on the preference information.

33. The method of claim 32, wherein the one or more ML models are determined based on at least one of a power consumption, an accuracy, validity, user preference, or priority of each ML model.

34. The method of claim 32, wherein the model preference information is transmitted via at least one of a measurement report or user equipment (UE) assistance information.

35. The method of claim 22, wherein the method is performed by a user equipment (UE) in communication with at least one of a mobile device, a network, or autonomous vehicles.

36. A user equipment (UE) comprising:
at least one transceiver;
at least one processor; and
at least one memory operatively coupled to the at least one processor and storing instructions that, based on being executed by the at least one processor, perform operations comprising:
receiving, from a network, a configuration for measurement reporting related to a plurality of machine learning (ML) models;
determining a set of ML models for measurement reporting among the plurality of ML models configured for the UE, based on the configuration;
obtaining measurement results by taking inputs to the set of ML models; and
transmitting, to the network, at least one of the measurement results.

37. A network node comprising:
at least one transceiver;
at least one processor; and
at least one memory operatively coupled to the at least one processor and storing instructions that, based on being executed by the at least one processor, perform operations comprising:
transmitting to a user equipment (UE), a configuration for measurement reporting related to a plurality of machine learning (ML) models; and
receiving, from the UE, at least one of measurement results obtained by taking inputs to a set of ML models for measurement reporting,
wherein the set of ML models are determined among the plurality of ML models configured for the UE, based on the configuration.
